(19) United States
(12) Patent Application Publication
(10) Pub. No.: US 2020/0033138 A1
(43) Pub. Date: Jan. 30, 2020

(54) VEHICLE CONTROL SYSTEM, MANAGEMENT TABLE PRODUCTION METHOD, AND RECORDING MEDIUM

(71) Applicant: HONDA MOTOR CO., LTD., Tokyo (JP)

(72) Inventors: Yusuke OKOBA, Kitakyushu-shi, Fukuoka (JP); Kenji HIGUCHI, Kitakyushu-shi, Fukuoka (JP); Hitoshi KONISHI, Wako-shi, Saitama (JP); Shuichi SUTO, Tokyo (JP); Masaaki OHIRA, Tokyo (JP); Noriyuki SAITO, Tokyo (JP)

(21) Appl. No.: 16/603,820

(22) PCT Filed: Mar. 2, 2018
(86) PCT No.: PCT/JP2018/008120

§ 371 Date: Oct. 8, 2019

(30) Foreign Application Priority Data
Apr. 10, 2017 (JP) 2017-077626

(51) Int. Cl. G01C 21/30; G01C 21/34; G08G 1/0968; G08G 1/0967

(52) U.S. Cl. CPC G01C 21/30; G08G 1/096725; G08G 1/096827; G01C 21/34

(57) ABSTRACT

A vehicle control system or the like is provided, suitable for providing traveling vehicle control using vehicle control map data to be used for a purpose differing from that of route search map data in part or all of a route found in the route search based on the route search map data. Navigation apparatus 3 searches for a route using route search map data. Judgment unit 27 of control apparatus 5 identifies a route section having vehicle control map data, using a table in table storage unit 23. Vehicle control unit 31 performs vehicle control using vehicle control map data. Table storage unit 23 manages intersection regions including intersection-shape-representing intersection polygons in the vehicle control map data. Judgment unit 27 performs matching between node position information in route and intersection regions. Employing position information, this supports a combination of route search and vehicle control without particularly requiring map data modification.

### TECHNICAL FIELD

The present invention relates to a vehicle control system, a management table production method, and a recording medium, and particularly to a vehicle control system or the like configured to search for a route using route search map data, and to control a moving body configured as a vehicle.

### BACKGROUND ART

Conventional navigation systems employ route search map data for searching for a traveling route. For example, description has been made in Patent documents 1 and 2 regarding a navigation system employing a plurality of route search map data.

### CITATION LIST

### Patent Literature

[Patent document 1]

Japanese Patent Application Laid Open No. 2001-222216
[Patent document 2]

Japanese Patent Application Laid Open No. 2009-47621

### SUMMARY OF INVENTION

### Technical Problem

In recent years, there has been increased interest with respect to automated driving technology. However, conventional navigation systems are only required to determine a route from a departure point up to a destination point. Accordingly, the route search map data does not have sufficiently high precision for providing vehicle control.

Such route search map data has been prepared almost nationwide. In contrast, high-precision vehicle control map data that can provide vehicle control is in a stage of preparation. For example, such high-precision vehicle control map data has been prepared for only a part of the expressways or the like.

Description has been made in Patent documents 1 and 2 regarding an arrangement in which a navigation system uses a plurality of map data. However, with such an arrangement, the plurality of map data is used for the same purpose, i.e., for searching for a route. Accordingly, such an arrangement is not applicable to a combination of map data to be used for different purposes, i.e., route search map data for searching for a route and vehicle control map data for providing vehicle control.

For example, with a data conversion method described in Patent document 1, data conversion is performed using a point included in common in the two map data. For example, an intersection is represented by a point in the route search map data. In contrast, in the vehicle control map data, such an intersection is represented by an area having a predetermined space required to allow a vehicle to pass through. That is to say, even in a case in which the same “intersection” is represented, there is a difference in representation between such a plurality of map data to be used for different purposes.

With a navigation apparatus described in Patent document 2, when high-precision route search map data exists for a section where a route search is to be performed, the high-precision route search map data is used as supplementary map data for ordinary route search map data so as to provide route search, route display, etc. However, the two route search map data are used for the same purpose, i.e., in order to support a route search. That is to say, the purpose of such an arrangement is to provide a high-quality service for the same technical field, i.e., for the “route search technique”. Accordingly, it is difficult to apply such an arrangement so as to provide a novel service based on a combination of multiple different services.

Accordingly, it is a purpose of the present invention to provide a vehicle control system or the like suitable for providing traveling vehicle control using vehicle control map data to be used for a purpose that differs from that of route search map data in a part of or otherwise the whole of a route found in the route search based on the route search map data.

### Solution of Problem

A first aspect of the present invention relates to a vehicle control system. The vehicle control system comprises: a route search map data storage unit configured to store route search map data; a vehicle control map data storage unit configured to store vehicle control map data used for vehicle control; a table storage unit configured to store a presence/absence management table; a route search unit configured to identify position information of multiple nodes corresponding to intersections on a route, and link data connecting the nodes, using the route search map data; and a judgment unit configured to judge sections on the route for which the vehicle control map data exists, which is used for vehicle control. The presence/absence management table comprises position information representing an intersection region that is a polygonal region including an intersection in the vehicle control map data, and presence/absence information representing presence or absence of vehicle control map data at a position corresponding to an intersection. By searching in the route for a particular intersection having a position that can be judged to match a position within the intersection region based on comparison between position information with respect to the nodes in the route and position information representing the intersection regions, and by judging, based on the presence/absence information, the presence or absence of the vehicle control map data at a position that corresponds to the particular intersection, the judgment unit judges whether or not the vehicle control map data exists for a given section on the route.

A second aspect of the present invention also relates to the vehicle control system according to the first aspect. The table storage unit further stores a facility management table for identifying an intersection to be set as a start point of a section on the route for which the vehicle control map data exists. The vehicle control system further comprises a start point search unit configured to acquire an intersection to be set as the start point with reference to the facility management table.

A third aspect of the present invention relates to a management table production method for producing a management table that manages an intersection region determined using vehicle control map data to be used for vehicle control. The vehicle control map data includes lane data with respect to lanes passable by a vehicle. The management table production method comprises: determining in which a management unit included in an information processing apparatus identifies an intersection polygon for each of multiple intersections based on a width of a road approaching the intersection and a width of a road exiting the intersection, and determines the intersection region including this intersection polygon; and producing the management table by adding data with respect to the vehicle control map data that corresponds to each of the intersection regions thus determined.

A fourth aspect of the present invention also relates to the management table production method according to the third aspect. The management table production method further comprises updating the vehicle control map data. In the determining and the producing, the management unit determines each intersection region using the updated vehicle control map data so as to produce the management table. The management table production method further comprises deletion information adding in which, when an intersection has been deleted in updating of the vehicle control map data, the management unit adds information with respect to the corresponding intersection region, which indicates that the intersection has been deleted, to the updated management table.

A fifth aspect of the present invention relates to a computer-readable recording medium. The computer-readable recording medium stores a program for instructing a computer for vehicle control to function as: a route search map data storage unit configured to store route search map data, a vehicle control map data storage unit configured to store vehicle control map data to be used for vehicle control, a table storage unit configured to store a presence/absence management table, a route search unit configured to identify position information with respect to multiple nodes corresponding to intersections on a route, and link data connecting the nodes, using the route search map data, and a judgment unit configured to judge sections on the route where the vehicle control map data exists, which are to be used for vehicle control. The presence/absence management table comprises position information representing an intersection region configured as a polygonal region including an intersection in the vehicle control map data, and presence/absence information that indicates presence or absence of vehicle control map data at a position corresponding to an intersection. By searching in the route for a particular intersection having a position that can be judged to match a position within the intersection region based on comparison between position information with respect to the nodes in the route and position information representing the intersection regions, and by judging, based on the presence/absence information, the presence or absence of the vehicle control map data at a position that corresponds to the particular intersection, the judgment unit judges whether or not the vehicle control map data exists for a given section on the route.

It should be noted that the present invention may be understood as a table or the like, which is a data structure used for processing of accessing vehicle control map data in order to control a moving body. The present invention may also be understood as a program for realizing each aspect of the present invention, and further as a computer-readable recording medium for storing this program in a stable manner.

Also, with such an arrangement in which the date of updating is managed for each section in a presence/absence table, by referencing the date of updating of a particular section in the presence/absence table that has matched a given route, this allows judgment to be made regarding whether or not vehicle control map data to be used for the route has been updated. This enables updating of only vehicle control map data requiring updating, thereby allowing only minimally necessary data to be updated.

Accordingly, this provides suppression of the amount of communication and improved updating speed.

### Advantageous Effects of Invention

According to the present invention, route searching and vehicle control are supported using route search map data and vehicle control map data, which are map data for different purposes.

### BRIEF DESCRIPTION OF DRAWINGS

FIG. 1A is a block diagram showing an example of a configuration of a vehicle control system 1 according to an embodiment of the present invention, and FIG. 1B is a diagram showing a relation between data to be used in processing executed by the vehicle control system 1.

FIG. 2A is a diagram showing a data structure of a vehicle control map data presence/absence table employed by the vehicle control system 1, and FIG. 2B is a diagram showing a relation between the vehicle control map data presence/absence table and the vehicle control map data.

FIG. 3 is a flowchart showing an example of the operation of the vehicle control system 1 shown in FIG. 1.

FIG. 4 is a diagram showing an outline of an example of the processing executed by the vehicle control system 1.

FIG. 5 is a diagram for explaining a facility management table.

FIG. 6 is a diagram for explaining the vehicle control map data presence/absence table in the vicinity of a fork on a road and the processing executed by a judgment unit 27 using the vehicle control map data presence/absence table.

FIG. 7 is a diagram for explaining a left/right judgment table.

FIG. 8 is a diagram showing an example of updating of the vehicle control map data.

### DESCRIPTION OF EMBODIMENTS

Description will be made below with reference to the drawings regarding an example of the present invention. It should be noted that an embodiment of the present invention is not restricted to such an example as described below.

### EXAMPLE

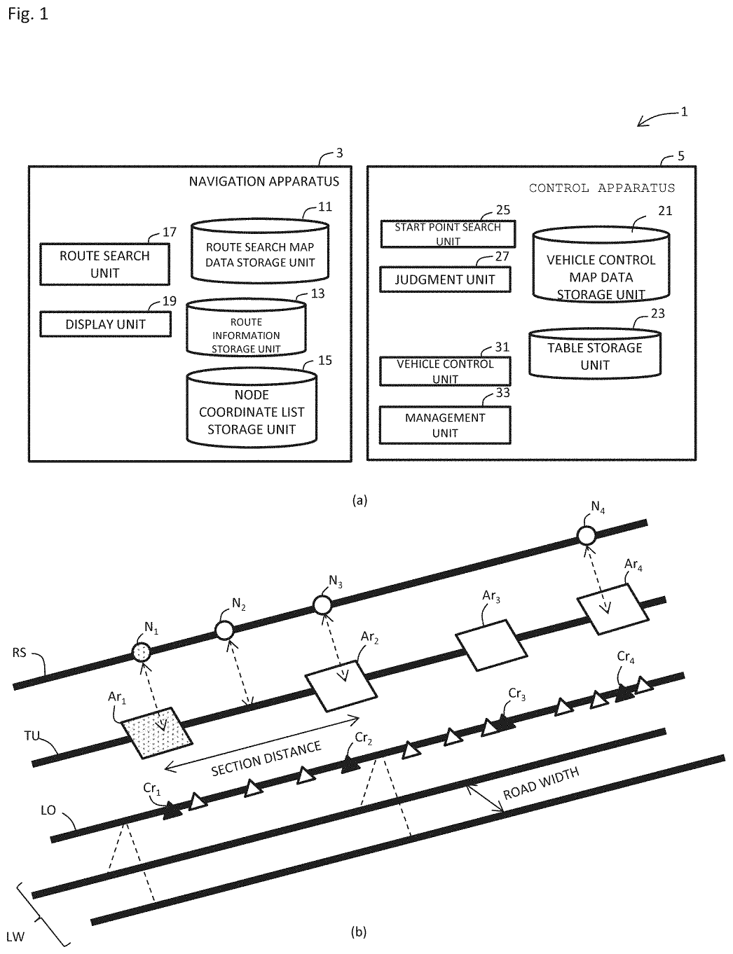

FIG. 1A is a block diagram showing an example of a configuration of a vehicle control system 1 according to an embodiment of the present invention. FIG. 1B is a diagram showing a relation between a route found in the route search by means of a navigation apparatus 3, vehicle control map data stored in a vehicle control map data storage unit 21, and a table stored in a table storage unit 23. Description will be made regarding an example that provides automobile vehicle control.

Referring to FIG. 1A, the vehicle control system 1 includes a navigation apparatus 3 and a control apparatus 5.

The navigation apparatus 3 includes a route search map data storage unit 11 (an example of “route search map data” in the claims), a route information storage unit 13, a node coordinate list storage unit 15, a route search unit 17 (an example of a “route search unit” in the claims), and a display unit 19.

The route search map data storage unit 11 stores route search map data. The route search map data includes a plurality of node information that represents nodes each representing an intersection and a plurality of link information that represents links each connecting the corresponding nodes. The display unit 19 is configured as a touch panel, for example. The display unit 19 is capable of displaying information for the driver or the like, and allows the driver or the like to input information. When the driver or the like operates the display unit 19 so as to input a departure point and a destination point, the route search unit 17 searches for a route from the departure point up to the destination point using the route search map data. The route is determined based on the plurality of node information and the link information that represents the connections between the nodes. The route search unit 17 instructs the route information storage unit 13 to store the route. The route search unit 17 can be provided as a software application or the like, for example. The route search unit 17 instructs the node coordinate list storage unit 15 to store the position information (e.g., coordinate position based on the latitude and the longitude) for each node included in the route in the order in which they are to appear.

The control apparatus 5 includes a vehicle control map data storage unit 21 (an example of a “vehicle control map data storage unit” in the claims), a table storage unit 23 (an example of a “table storage unit” in the claims), a start point search unit 25 (an example of a “start point search unit” in the claims), a judgment unit 27 (an example of a “judgment unit” in the claims), a vehicle control unit 31, and a management unit 33 (an example of a “management unit” in the claims).

The vehicle control map data storage unit 21 stores the vehicle control map data to be used for vehicle control. The vehicle control map data includes high-precision lane data including position information that represents the center line of each lane where a vehicle is able to pass through, a plurality of node information each representing a node that corresponds to an intersection, and logical data having a plurality of link information each representing a link that connects the corresponding nodes. It should be noted that the position information is stored in the form of a coordinate position (latitude and longitude). Each link represented by the logical data is associated with the corresponding section represented by the high-precision lane data. Accordingly, this arrangement is capable of providing information that a given link in the logical data corresponds to a particular section in the high-precision data.

The route search map data is configured with spatial granularity that is larger than that of the vehicle control map data. For example, the route search is only required to judge the presence or absence of a route from the departure point up to the destination point. However, the vehicle control is required to determine the positions on a road via which the vehicle is to travel, for example. Accordingly, the vehicle control cannot be provided based only on the route search map data because it is configured with large granularity and has only insufficient information.

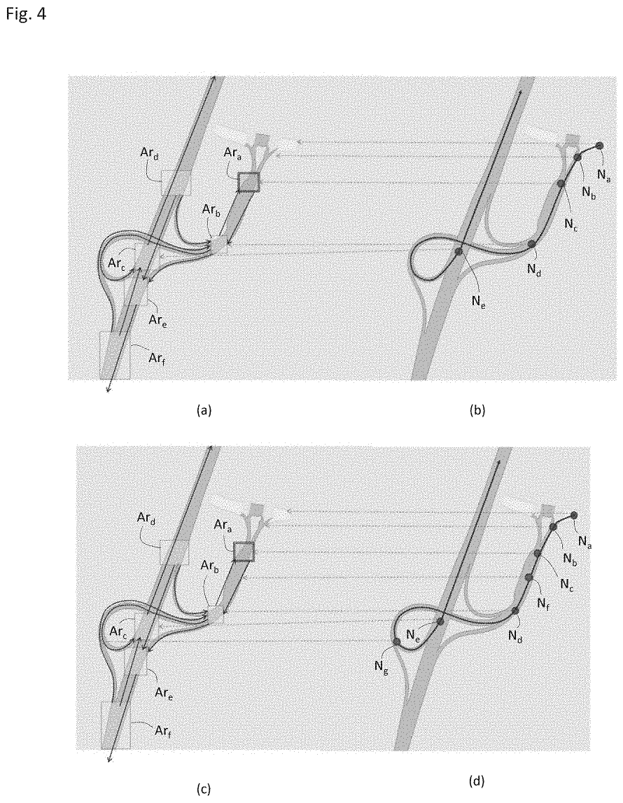

In contrast, the vehicle control map data has sufficient information for providing vehicle control. However, the vehicle control map data has an enormous amount of information. Furthermore, there is a difference in usage between the logical data of the vehicle control map data and the route search map data. For example, in some cases, the node position of a given intersection does not match the corresponding node position. Also, in some cases, the node positions of given intersections do not match the corresponding node positions in a one-to-one manner (see FIG. 4). Furthermore, typical navigation apparatuses are required to be modified. Accordingly, it is difficult to provide the route search based only on the vehicle control map data without the route search map data. That is to say, popularization of such an arrangement would require a long development time and enormous effort.

As described above, at present, it is difficult to support both the route search and the vehicle control based only on one from among the vehicle control map data and the route search map data. Furthermore, the vehicle control map data exists for a part of sections of the areas for which the route search map data exists.

The table storage unit 23 stores a facility management table (an example of a “start point search table” in the claims), a vehicle control map data presence/absence table (an example of a “presence/absence table” in the claims), a search link ID list table, a left/right judgment table, and a route list.

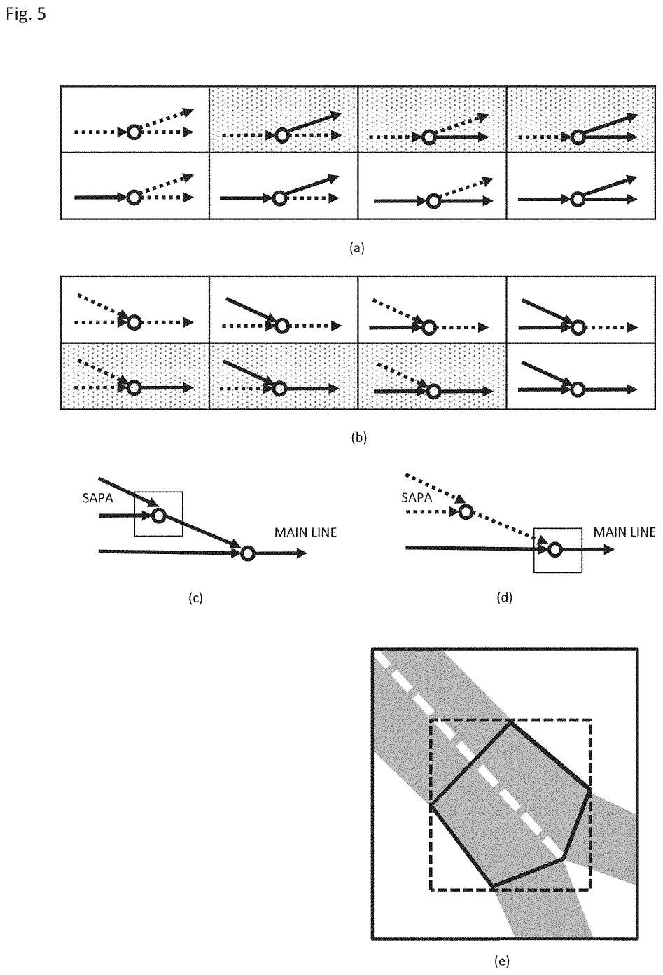

The facility management table is used to identify an intersection to be used as a start point for a section for which the vehicle control map data exists, from among the intersections on the route found in the route search based on the route search map data. Each intersection managed by the facility management table will be referred to as a “facility intersection”. The region including each facility intersection managed by the facility management table will be referred to as a “facility intersection region”. The facility management table is configured as a collection of region information that represents the facility intersection regions that can be used as the start point in the section for which the vehicle control map data exists. Each region information includes a region ID that is information for identifying the region information, coordinate information that indicates the latitude and longitude position of the lower-left corner of the facility intersection region and the latitude and longitude position of the upper-right corner thereof, and connection destination information that indicates section information (which will be described below) provided by the vehicle control map data presence/absence table with respect to a connection destination to be connected to the facility intersection region. Specific description will be made later with reference to FIG. 5 regarding the facility management table.

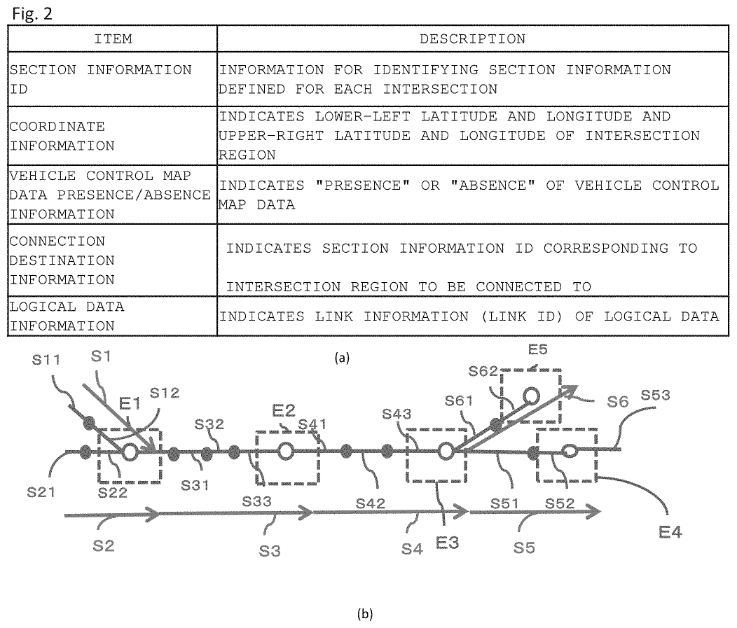

FIG. 2A is a diagram showing a data structure of the vehicle control map data presence/absence table employed in the vehicle control system 1. FIG. 2B is a diagram showing a relation between the vehicle control map data presence/absence table and the vehicle control map data.

Description will be made with reference to FIG. 2A regarding the data structure of the vehicle control map data presence/absence table employed in the vehicle control system 1. The vehicle control map data presence/absence table is configured as a collection of section information defined for each intersection region. Each section information includes a section information ID which is information for identifying the section information, coordinate information that indicates the latitude and longitude position of the lower-left corner of the corresponding intersection region and the latitude and longitude position of the upper-right corner thereof, vehicle control data presence/absence information that indicates the presence or absence of the vehicle control map data existing for the position that corresponds to the intersection region, connection destination information (section information ID of the connection destination to be connected) that indicates the destination intersection region to be connected to the intersection region, and information (link ID) for identifying link information of the logical data that corresponds to a link between the intersection region and the connection origin intersection region. It should be noted that FIG. 2A shows section information with respect to a single section that forms the vehicle control map data presence/absence table.

Description will be made with reference to FIG. 2B regarding the relation between the vehicle control map data presence/absence table and the vehicle control map data. The reference symbols “E1” through “E5” each represent an intersection region (intersection region defined by the coordinate information) defined for each intersection region included in the section information indicated by the vehicle control map data presence/absence table. “S1” through “S6” each represent a section (between an intersection region and a connection origin intersection region) in the vehicle control map data presence/absence table. “S11” through “S62” each represent link information of the logical data. The section information including the intersection region E1 includes the link information S11 through S22 for indicating the logical data. The section information including the intersection region E2 includes the link information S31 through S33 for indicating the logical data. The section information including the intersection region E3 includes the link information S41 through S43 for indicating the logical data. The section information including the intersection region E4 includes the link information S51 and S52 for indicating the logical data. The section information including the intersection region E5 includes the link information S61 and S62 for indicating the logical data. Furthermore, the section information including the intersection region E1 includes, as the connection destination information, the section information including the intersection region E2. The section information including the intersection region E2 information includes, as the connection destination information, the section information including the intersection region E3. The section information including the intersection region E3 information includes, as the connection destination information, the section information including the intersection region E4 and the section information including the intersection region E5.

The vehicle control map data presence/absence table is divided into: a main line table storing only the expressway main line sections as registered information; and a facility table storing facility sections such as IC (interchange), SAPA (service area/parking area), and JCT (junction) facilities as registered information.

The search link ID list table is a table for storing the link IDs assigned to the vehicle control map data. The link ID is configured as a unique ID (value) assigned to the link information storing the intersection-intersection information defined in the vehicle control map data. The link ID is configured as a part of the data stored in the vehicle control map data presence/absence table, which is used as reference data by specifying an offset based on the section information. The link ID is stored in units of sections. By acquiring the search link ID, this allows the control apparatus 5 to provide a high-speed data reference operation. The link ID is not directly stored in the main line table, the facility table, or the left-right judgment table. Instead, the link ID is stored in another table, i.e., the search link ID list table. From among the search link IDs defined in a given record (section) registered in the main line table and the facility table, the link IDs associated with the high-precision lane data are stored in the search link ID list table. Each section data is sequentially stored in the traveling direction. Each record is stored in order from the “main line table” to the “facility table”. The main line table is stored in the same order as that of the main lines. The facility table may be stored in a desired order.

When the departure intersection and the destination intersection of a given section matches those of another section, both the left and right sections are registered in the left-right judgment table.

The route list is a table for registering the route ID numbers defined in the vehicle control map data presence/absence table so as to manage connection information with respect to the connections between the routes. This allows the vehicle control map data presence/absence table to be managed in a divided manner in units of routes. This allows the connection information to be created in units of routes, thereby allowing the connection information to be updated in a differential manner. In a case in which differential updating is not supported, the route list is not required.

The start point search unit 25 uses the facility management table as a reference table, so as to search for the start point to be used for the vehicle control map data presence/absence judgment operation using the nodes in the route found in the route search. The judgment unit 27 judges whether or not the vehicle control map data exists for each section on the route. When judgment is made that the vehicle control map data exists for a given section, the judgment unit 27 transmits information to the navigation apparatus 3 that the vehicle control map data exists for this section. When the route is displayed, the display unit 19 further displays the information that the vehicle control map data exists.

In a case in which the vehicle control map data exists for a given section, in this section, the vehicle control unit 31 reads the vehicle control map data so as to control the vehicle. Examples of the vehicle control include vehicle driving assistance (e.g., an audio warning, a visual warning, steering control, acceleration/deceleration control, guidance control, etc.).

When the table storage unit 23 stores no table, the management unit 33 newly generates each table. Even in a state in which the table storage unit 23 stores each table, when the vehicle control map data is updated, each table is also updated.

Description will be made with reference to FIG. 1B regarding the outline of processing using the route (RS) obtained in the route search, the vehicle control map data presence/absence table (TU), the vehicle control map data (logical data (LO) and high-precision lane data (LW)). Description will be made assuming that each intersection region including an intersection is represented by a rectangular region, for example, which can be identified by the position information that indicates the opposing corners thereof.

The logical data (LO) manages multiple intersections along the road. In FIG. 1B, the point that corresponds to each intersection is indicated by a solid triangle. Each change point at which the shape or the property in the logical data changes is indicated by an open triangle. Here, intersection regions Ar₁, Ar₂, Ar₃, and Ar₄ are defined corresponding to the solid triangles Cr₁, Cr₂, Cr₃, and Cr₄. Each intersection region is defined such that it includes an intersection polygon determined using the road width defined in the lane data (LW).

Let us consider a case in which the start point search unit 25 judges with reference to the facility management table that the facility intersection region Ar₁ that corresponds to the node N₁ is to be used as the start point. The judgment unit 27 acquires the position information with respect to the node N₂ next to N₁ with reference to the node coordinate list. Furthermore, the judgment unit 27 acquires the intersection region Ar₂ next to the Ar₁ with reference to the vehicle control map data presence/absence data. Subsequently, the judgment unit 27 performs the matching processing between the node N₂ and the intersection region Ar₂. In this example, the matching fails. Accordingly, the judgment unit 27 performs the matching processing between the position information with respect to the next node N₃ and the intersection region Ar₂. In this example, the matching is successful. Furthermore, the judgment unit 27 performs the matching processing between the next node N₄ and the next intersection region Ar₃. In this example, the matching fails. Subsequently, the judgement unit 27 performs the matching processing between the node N₄ and the intersection region Ar₄. In this example, the matching is successful.

Accordingly, the judgment unit 27 judges that the vehicle control map data exists for the route from the node N₁ up to the node N₄ found in the route search. The judgment is performed using the position information. The plurality of map data have the position information in common. Accordingly, by preparing each table, this arrangement is capable of providing the judgment processing without a need for special modifications of the route search map data and the vehicle control map data.

It should be noted that the matching processing may be omitted using information with respect to the section distance or the like. For example, when the difference between the section distance from N₁ up to N₂ and the section distance from Ar₁ up to Ar₂ is not within a predetermined range, the matching processing between the node N₂ and the intersection region Ar₂ may be omitted. Instead, the matching processing may be performed between the next node N₃ and the intersection region Ar₂. Also, the matching processing may be performed between the node N₂ and the intersection region Ar₃. Also, the matching processing may be performed between the node N₃ and the intersection region Ar₃.

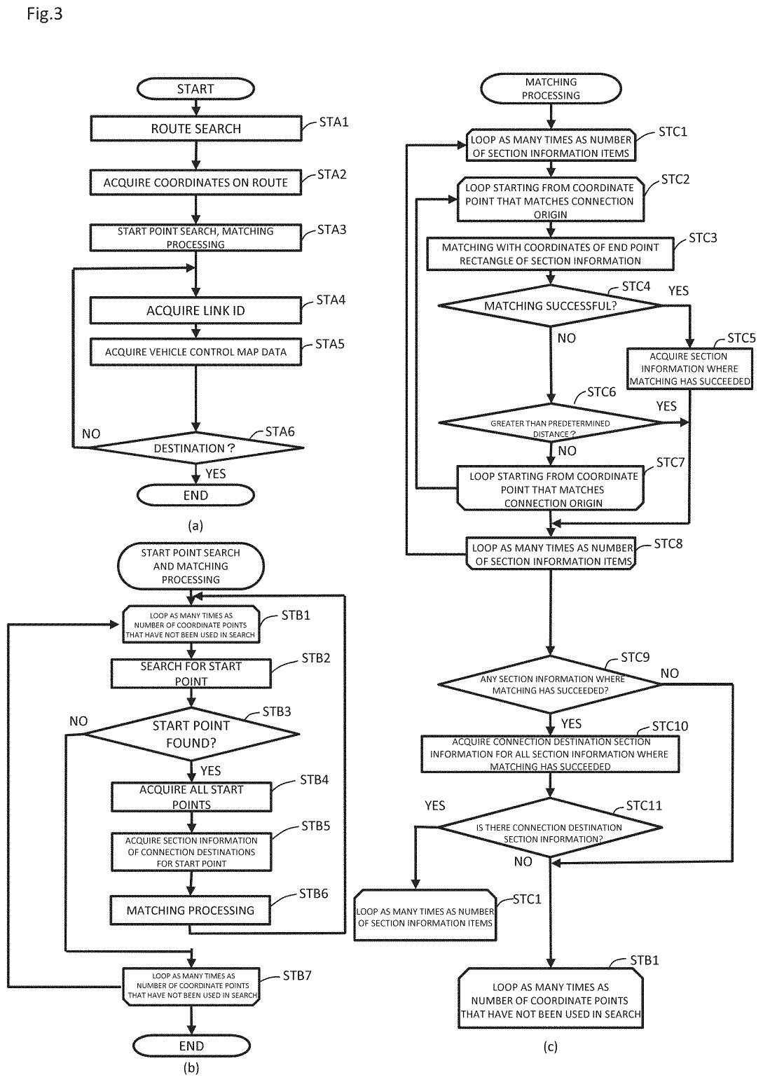

FIG. 3 is a flowchart showing an example of the operation of the vehicle control system 1 shown in FIG. 1.

Referring to FIG. 3A, when the driver or the like operates the display unit 19 so as to input the departure point and the destination point, the route search unit 17 searches for a route from the departure point up to the destination point using the route search map data (Step STA1). The route search unit 17 instructs the route information storage unit 13 to store the route thus found in the route search. The route search unit 17 acquires the position information with respect to the nodes included in the route, and instructs the node coordinate list storage unit 15 to store the node coordination list (Step STA2).

The start point search unit 25 uses the facility management table as a reference table so as to search for a node that can be used as the start point for the vehicle control map data presence/absence judgement from among the nodes in the route. The judgment unit 27 judges whether or not the vehicle control map data exists for each section in the route (Step STA3). Specific description will be made with reference to FIGS. 3B and 3C regarding the processing in Step STA3.

In Step STA4, the vehicle control unit 31 uses the vehicle control map data presence/absence table as a reference table so as to acquire the link ID of the logical data to be used to access the vehicle control map data for the section (Step STA4). The vehicle control unit 31 acquires the vehicle control map data using the link ID (Step STA5). Subsequently, the flow proceeds to Step STA6.

In step STA6, the vehicle control unit 31 judges whether or not the vehicle has reached the destination point. When judgment has been made that the vehicle has reached the destination point, the processing ends. Otherwise, the flow returns to Step STA4.

Specific description will be made with reference to FIG. 3B regarding the processing in Step STA3. The processing in Steps STB1 through STB7 is repeated the same number of times as the number of node coordinate positions stored in the node coordinate list acquired in STA2. It should be noted that, when the second or subsequent start point search is performed after the matching fails for the section information, the loop is started from the node coordinate position that has not been used for the matching. In Step STB2, the start point search unit 25 uses the node coordinate list as a reference list so as to make a comparison between the coordinate position of each node and each facility intersection region stored in the facility management table, in order to search for the start point. The judgment unit 27 judges whether or not the start point has been detected (STB3). When judgement has been made that the start point has not been detected, the flow proceeds to Step STB7, and the processing in Step STB2 and the subsequent steps are repeated for the coordinate position of the next node. When judgment has been made that at least one start point has been detected, one or multiple start points are all acquired (Step STB4). Furthermore, using the vehicle control map data presence/absence table as a reference table, the section information is acquired for all the sections that can be connected to the start point thus detected (Step STB5). The “start point” as used here represents an intersection positioned at the start point of a section on a route for which the vehicle control map data exists. In a case in which there are multiple intersections in the vicinity of each other or otherwise in a case in which there is a three-dimensional intersection, in some cases, multiple start points are detected for a single node.

The judgment unit 27 uses the node coordinate list as a reference list so as to sequentially perform matching processing, based on the vehicle control map data presence/absence table, between the subsequent nodes of the start-point matching node and the subsequent section information that can be connected to the start point thus acquired in Step STB 5 (Step STB6). When the matching fails between the section information and a given node coordinate position on the route, the step STB1 is repeated for this node. Examples of such a case in which the flow returns to STB1 include: a case in which, after the vehicle exits from an expressway, the vehicle enters the expressway again; and a case in which the start point search is performed again.

Further specific description will be made with reference to FIG. 3C regarding the processing in Step STB6. The processing in Steps STC1 through STC8 are looped the same number of times as the number of items of section information acquired in Step STB5 or Step STC10. Here, the number of items of section information is the number of items of section information for the start point and the connection destinations. Furthermore, in the processing in Steps STC2 through STC7, matching processing is performed between the coordinate position of each of the subsequent nodes of the node matched with the section information of the connection origin (e.g., a node matched with the start point or a node matched with the section information) and the coordinate position of a rectangle that represents the connection destination included in the section information (Step STC3). The judgment unit 27 judges whether or not the matching is successful in the matching operation (Step STC4). When the matching has been successful, the section information thus matched is acquired (Step STC 5), following which the flow proceeds to Step STC8. When the matching has failed, judgment is made whether or not the matching processing has been repeated until the section distance defined in the section information becomes larger than a predetermined distance (Step STC6). When judgment has been made that matching has failed, judgement is made that the section distance has become larger than the predetermined distance, and the flow proceeds to Step STC8. Otherwise, the flow proceeds to Step ST7, following which, the matching processing is performed using the position information with respect to the next node.

Subsequently, judgment is made regarding whether or not there is a section for which the matching has been successful in the processing in Steps STC1 through STC8 (Step STC9). When judgment has been made that there has been no successful matching, the flow returns to the start point search processing. In a case in which a given connection origin fails to match the section information for all the connection destinations, judgment can be made that such a connection origin is an end point of a particular section for which the vehicle control map data exists. When there is at least one successful matching, the connection destination information is acquired for all the matched sections (Step STC10). Furthermore, judgment is made regarding whether or not there is section information (connection destination section information) that can be connected (Step STC11). When such section information exists, the flow returns to Step STC1 in order to perform the matching processing for the connection destination section information. Otherwise, judgement is made that the matched section information corresponds to an end point section of a section for which the vehicle control map data exists, or otherwise the NW end point. Accordingly, in this case, the flow returns to the start point search processing (Step STB1). By executing the above-described processing, each section for which the vehicle control map data exists can be detected from a route found in the route search using the route search map data. Furthermore, the section information stored in the vehicle control map data presence/absence table includes the link ID assigned to the link information of the logical data. Moreover, the link information of the logical data is associated with each section of the high-precision lane data. Accordingly, this allows judgment to be made regarding which section data is to be used from among the high-precision lane data with respect to the sections for which the vehicle control map data exists.

Description will be made with reference to FIG. 4 regarding the outline of the processing according to the present example with reference to an example that is close to an actual road. In FIGS. 4A and 4C, “Arₐ” indicates a facility intersection region defined in the facility management table. “Ar_{b}” through Ar_{f} each indicate an intersection region defined in the vehicle control map data. Each arrow indicates the connection destination information.

FIG. 4B shows nodes Nₐ through Nₑ obtained in the route search. The start point search unit 25 searches for the start point from among the nodes in the order in which they are to appear. In this example, there is no facility intersection region that corresponds to Nₐ or N_{b}. Accordingly, judgment is made that neither Nₐ nor N_{b} can be selected as the start point. The node N_{c} matches the facility intersection region Arₐ. Accordingly, Arₐ is selected as the start point.

Subsequently, the judgment unit 27 performs the matching processing between the section information for the connection destination to be connected to the start point and the next coordinate position on the route. That is to say, the matching processing is performed between the node N_{d} and the intersection region Ar_{b}, and, in this case, they match.

Furthermore, the matching processing is performed between the section information for a subsequent connection destination and the next coordinate position on the route so as to identify the matched section information. In this example, there are two connection destinations that can be connected to the intersection region Ar_{b}, i.e., Ar_{c} and Arₑ. Matching processing is performed between the intersection regions Ar_{c} and Arₑ and the node Nₑ. In this case, the node Nₑ matches the intersection region Ar_{c}. Subsequently, the same matching processing is repeatedly performed until the matching fails. By repeatedly performing the start point search from the node for which the matching fails, such an arrangement is capable of identifying the next start section for which the vehicle control map data exists.

FIG. 4D shows the nodes Nₐ through N_{q} obtained in the route search based on route search map data that differs from that shown in FIG. 4B. In this case, there are additional nodes, i.e., N_{f} and N_{q}, as compared with the example shown in FIG. 4B. As with the example shown in FIG. 4B, the node N_{c} matches the facility intersection region Arₐ. Accordingly, the start point search unit 25 selects Arₐ as the start point. The judgment unit 27 performs the matching processing for the node N_{f}. However, the matching fails. Accordingly, the processing for the node N_{f} is skipped, and the matching processing is performed for the next node Nₐ. In this step, the node N_{d} matches the area Ar_{b}. The matching processing for the next node N_{g} fails. However, the next node Nₑ matches the intersection region Ar_{c}. It should be noted that, in a case in which the section distance is within a distance registered in the section information+α, the skip processing is allowed.

Specific description will be made with reference to FIG. 5 regarding the facility management table. The facility management table is configured to allow the start point to be searched for with high speed with respect to the vehicle control map data. Each facility intersection managed by the facility management table satisfies all the following conditions. That is to say, as the facility intersection, no vehicle control map data exists for at least one approach section of the intersection. Furthermore, as the facility intersection, the vehicle control map data exists for at least one exit section of the intersection. The facility intersection indicates the start point of the section for which the vehicle control map data exists.

FIGS. 5A and 5B show the facility intersections and the other intersections in a case in which they are configured as forks and junctions. Each solid arrow represents a section for which the vehicle control map data exists. Each dotted arrow represents a section for which the vehicle control map data does not exist. FIG. 5A shows three facility intersections, i.e., the intersections represented by the second, third, and fourth columns in the first row of the matrix. The other intersections are not defined as facility intersections. FIG. 5B shows three facility intersections, i.e., the intersections represented by the first, second, and third columns in the second row of the matrix. The other intersections are not defined as facility intersections.

FIGS. 5C and 5D shows an example with respect to a SAPA. In the following description, the “section with vehicle control map data” will represent a section on a main line, branch line, or the like, of a vehicle road such as an expressway for which the logical data of the vehicle control map data and the high-precision lane data exist. In contrast, the “section without vehicle control map data” represents a section for which the logical data of the vehicle control map data exists but the high-precision lane data does not exist, examples of which include a road leading to an ordinary road on which the vehicle travels after it exits from an expressway or the like via an IC. Each solid arrow represents a section with vehicle control map data. Each dotted arrow represents a section without vehicle control map data. As shown in FIG. 5C, in a case in which a given SAPA link that approaches a main line is designed as a section with vehicle control map data, the SAPA side is defined as the facility intersection. In contrast, as shown in FIG. 5D, in a case in which a given SAPA link that approaches a main line is designed as a section without vehicle control map data, the junction point is defined as a facility intersection.

The facility management table includes a data portion storing the data of the rectangular facility intersection regions or the like to be set as the start point, and a search portion for providing a high-speed data search. The search portion is used as the index data for the data portion.

Detailed description will be made regarding the coordinate information with respect to the intersection regions stored in the vehicle control map data presence/absence table. FIG. 5E shows an example of a rectangular region including an intersection polygon managed by the vehicle control map data presence/absence table. Such an intersection polygon has a large number of corners and has a large amount of data, which involves complicated matching processing. In contrast, in a case in which such an intersection is represented by a rectangular region, the intersection region can be identified by two coordinate positions of opposing corners thereof (e.g., the latitude/longitude position of the lower-left corner and the latitude/longitude position of the upper-right corner). This allows the matching processing to be performed in a simple manner.

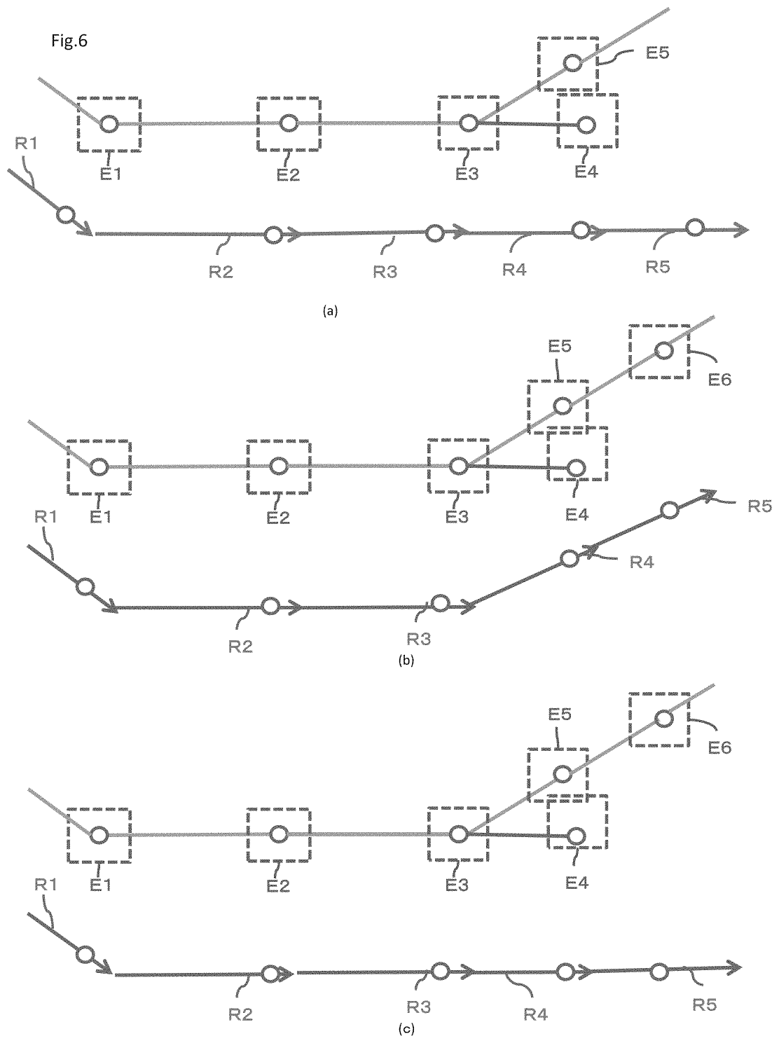

Specific description will be made with reference to FIG. 6 regarding the vehicle control map data presence/absence table and the processing using the vehicle control map data presence/absence table. FIGS. 6A, 6B, and 6C are diagrams for explaining the vehicle control map data presence/absence table and the processing executed by the judgment unit 27 using this table with respect to the regions in the vicinity of a fork in a road.

In FIG. 6A, the section from the intersection region E1 up to the intersection region E3 and the section from the intersection region E3 up to the intersection region E4 are each a section with vehicle control map data. In contrast, the section from the intersection region E3 up to the intersection region E6 is a section without vehicle control map data. “R1” through “R5” each represent a link (indicated by the straight line in the drawing) and a node (open circle in the drawing) included in the route determined by the route search unit 17 in the route search using the route search map data. Here, let us consider an example in which the node R1 matches the intersection region E1, the node R2 matches the intersection region E2, the node R3 matches the intersection region E3, and the node R4 matches the intersection region E4.

The judgment unit 27 performs the following processing. First, when the node R1 on the route found in the route search by the route search unit 17 matches the intersection region E1, the judgment unit 27 judges whether or not the intersection region E1 is a section with vehicle control map data. In this case, the intersection region E1 is a section with vehicle control map data. Accordingly, the judgment unit 27 judges that the intersection region E1 is a section with vehicle control map data. Subsequently, when the node R2 matches the intersection region E2, the judgment unit 27 judges whether or not the intersection region E2 is a section with vehicle control map data. In this example, the intersection region E2 is a section with vehicle control map data. Accordingly, the judgment unit 27 judges that the intersection region E2 is a section with vehicle control map data. Subsequently, when the node R3 matches the intersection region E3, the judgment unit 27 judges whether or not the intersection region E3 is a section with vehicle control map data. In this example, the intersection region E3 is a section with vehicle control map data. Accordingly, the judgment unit 27 judges that the intersection region E3 is a section with vehicle control map data. Subsequently, when the node R4 matches the intersection region E4, the judgment unit 27 judges whether or not the intersection region E4 is a section with vehicle control map data. In this example, the intersection region E4 is a section without vehicle control map data. Accordingly, the judgment unit 27 judges that the intersection region E4 is a section without vehicle control map data. In this stage, judgment is made that the intersection region E4 is a section without vehicle control map data, and accordingly, the processing ends.

By executing the above-described processing, this arrangement is capable of making a judgment that the section up to the node R3 is a section with vehicle control map data, and that the section ahead of the node R3 is a section without vehicle control map data.

In FIG. 6B, the section between the intersection regions E1 and E3 and the subsequent sections up to the intersection regions E5 and E6 are each a section with vehicle control map data. In contrast, the section from the intersection region E3 up to the intersection region E4 is a section without vehicle control map data. The intersection regions E4 and E5 overlap. “R1” through “R5” each represent a link (straight line in the drawing) and a node (open circle in the drawing) included in the route found in the route search by the route search unit 17 using the route search map data. Here, let us consider an example in which the node R1 matches the intersection region E1, the node R2 matches the intersection region E2, the node R3 matches the intersection region E3, the node R4 matches the intersection regions E4 and E5, and the node R5 matches the intersection region E6.

The judgment unit performs the following processing. First, when the node R1 found in the route search by the route search unit 17 matches the intersection region E1, the judgment unit 27 judges whether or not the intersection region E1 is a section with vehicle control map data. In this example, the intersection region E1 is a section with vehicle control map data. Accordingly, the judgment unit 27 judges that the intersection region E1 is a section with vehicle control map data. Subsequently, when the node R2 matches the intersection region E2, the judgment unit 27 judges whether or not the intersection region E2 is a section with vehicle control map data. In this example, the intersection region E2 is a section with vehicle control map data. Accordingly, the judgment unit 27 judges that the intersection region E2 is a section with vehicle control map data. Subsequently, when the node R3 matches the intersection region E3, the judgment unit 27 judges whether or not the intersection region E3 is a section with vehicle control map data. In this example, the intersection region E3 is a section with vehicle control map data. Accordingly, the judgment unit 27 judges that the intersection region E3 is a section with vehicle control map data. Subsequently, judgement is made that the node R4 matches both the intersection regions E4 and E5. In this example, the intersection regions E4 and E5 overlap. Accordingly, the judgment unit 27 judges whether or not the intersection region E4 is a section with map data and whether or not the intersection region E5 is a section with vehicle control map data. In this example, the intersection region E4 is a section without vehicle control map data. Accordingly, the judgment unit 27 judges that the intersection region E4 is a section without vehicle control map data. In contrast, the intersection region E5 is a section with vehicle control map data. Accordingly, the judgment unit 27 judges that the intersection region is a section with vehicle control map data. Subsequently, when the node R5 matches the intersection region E6, the judgment unit 27 judges whether or not the intersection region E6 is a section with vehicle control map data. In this example, the intersection region E6 is a section with vehicle control map data. Accordingly, the judgment unit 27 judges that the intersection region E6 is a section with vehicle control map data. In this processing, the intersection region E4 has been judged to be a matching intersection region. However, the intersection region E6 is also judged to be a matching intersection region. Accordingly, judgement can be made that false matching has been obtained for the intersection region E4.

By executing the above-described processing, judgment can be made that the section from E1 up to E3 and the section from E3 up to E6 are each a section with vehicle control map data.

In FIG. 6C, the route between the intersection regions E1 and E3 and the subsequent section up to the intersection regions E5 and E6 are each a section with vehicle control map data. In contrast, the route from the intersection region E3 up to the intersection region E4 is a section without vehicle control map data. The intersection regions E4 and E5 overlap. “R1” through “R5” each represent a link (straight line in the drawing) and a node (open circle in the drawing) included in the route found in the route search by the route search unit 17 using the route search map data. Here, let us consider an example in which the node R1 matches the intersection region E1, the node R2 matches the intersection region E2, the node R3 matches the intersection region E3, the node R4 matches the intersection regions E4 and E5, and the node R5 matches the intersection region E6.

The judgment unit performs the following processing. First, when the node R1 of the route found in the route search by the route search unit 17 matches the intersection region E1, the judgment unit 27 judges whether or not the intersection region E1 is a section with vehicle control map data. In this example, the intersection region E1 is a section with vehicle control map data. Accordingly, the judgment unit 27 judges that the intersection region E1 is a section with vehicle control map data. Subsequently, when the node R2 matches the intersection region E2, the judgment unit 27 judges whether or not the intersection region E2 is a section with vehicle control map data. In this example, the intersection region E2 is a section with vehicle control map data. Accordingly, the judgment unit 27 judges that the intersection region E2 is a section with vehicle control map data. Subsequently, when the node R3 matches the intersection region E3, the judgment unit 27 judges whether or not the intersection region E3 is a section with vehicle control map data. In this example, the intersection region E3 is a section with vehicle control map data. Accordingly, the judgment unit 27 judges that the intersection region E3 is a section with vehicle control map data. Subsequently, judgement is made that the node R4 matches both the intersection regions E4 and E5. In this example, the intersection regions E4 and E5 overlap. Accordingly, the judgment unit 27 judges whether or not the intersection region E4 is a section with vehicle control map data and whether or not the intersection region E5 is a section with vehicle control map data. In this example, the intersection region E4 is a section without vehicle control map data. Accordingly, the judgment unit 27 judges that the intersection region E4 is a section without vehicle control map data. In contrast, the intersection region E5 is a section with vehicle control map data. Accordingly, the judgment unit 27 judges that the intersection region is a section with vehicle control map data. Subsequently, matching is attempted between the node R5 and the intersection region E6, but matching between the node R5 and the intersection region E6 fails. Moreover, the intersection region E4 has been judged to be a section without vehicle control map data. Accordingly, the processing ends. In this processing, the intersection region E5 has been judged to be a matched intersection. However, the intersection region E6 is not judged to be a matched intersection. Accordingly, judgment can be made that false matching has been obtained for the intersection region E5.

By executing the above-described processing, judgment can be made that the section up to the node R3 is a section with vehicle control map data, and the section ahead of the node R3 is a section without vehicle control map data.

It should be noted that the judgment unit 27 judges whether a section is a section with vehicle control map data or a section without vehicle control map data based on the vehicle control map data presence/absence information.

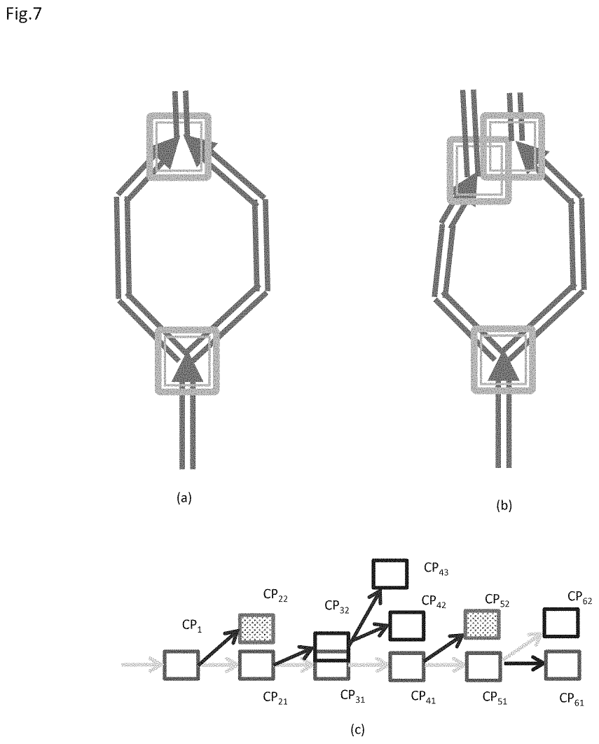

Description will be made with reference to FIGS. 7A through 7C regarding processing using the left-right judgment table. The left-right judgment table is a table for judging whether or not given routes have start points that overlap or end points that overlap. In matching processing for connection destination rectangles, when matching has been obtained for a particular connection destination section that is not a left-right judgment section, there is no need to perform the matching processing for the remaining connection destinations. This provides high processing speed. Such searching can be performed based on the vehicle control map data presence/absence table. It should be noted that, in order to support the same function, instead of using the left-right judgment table, each section information (main line table, facility table) may store fork directions.

As shown in FIG. 7A, in a case in which given routes have the same start point and the same end point, the sections that define such routes are registered in the left-right judgment table. Also, in a case in which given routes have the same start point and have end points defined by rectangular regions that overlap as shown in FIG. 7B, the corresponding sections are registered in the left-right judgment table. Once matching has succeeded for a particular connection destination that has not registered in the left-right judgment table, there is no need to perform matching processing for the remaining connection destinations. As a result, the processing for the main line that occupies the greater part of the navigation route is prioritized. Accordingly, a reduction in the amount of processing is anticipated. FIG. 7C show an example of matching processing. Intersection polygons CP₃₁ and CP₃₂ overlap, and are registered in the left-right judgment table. In a case in which matching is obtained for CP₂₁ using CPI as the start port, there is no need to perform matching processing for CP₂₂. However, even in a case in which matching is obtained for CP₃₁, matching processing is also necessary for CP₃₂. This is because CP₃₁ and CP₃₂ are registered in the left-right judgment table. When matching processing for CP₃₂ is successful, matching processing is performed for the subsequent CP₄₂ and CP₄₃. If matching is obtained for neither CP₄₂ nor CP₄₃, judgment is made that matching for CP₃₂ fails. In the same way, matching is performed for CP₄₁, and when matching for the subsequent CP₅₁ is obtained, there is no need to perform matching processing for CP₅₂. If matching processing for CP₆₁ fails, matching processing is performed for CP₆₂.

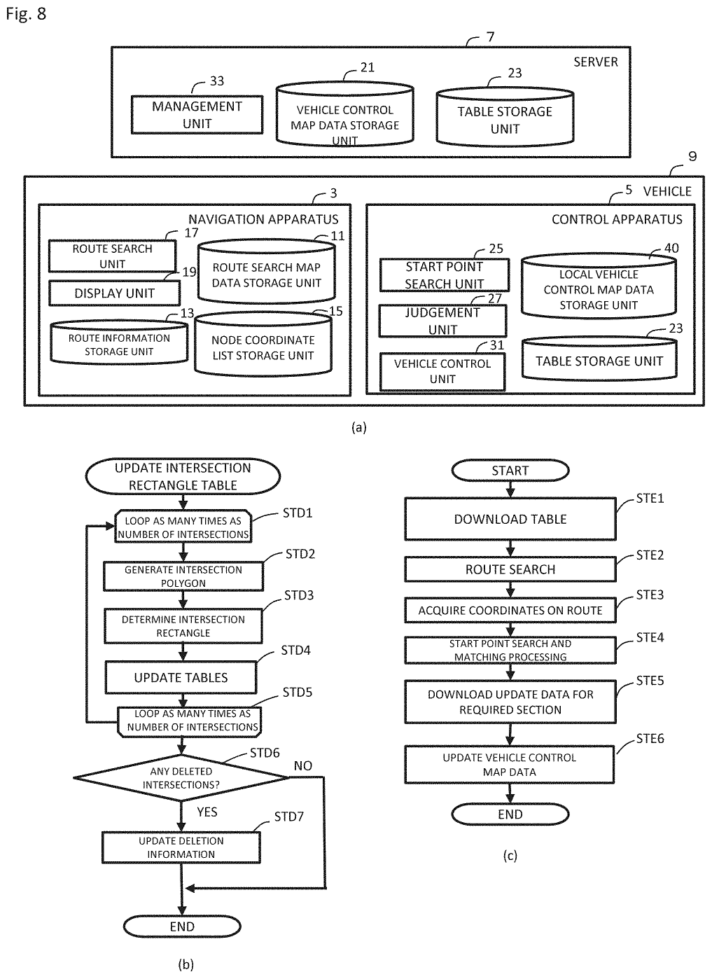

FIGS. 8A through 8C show an example of updating processing for vehicle control map data. As shown in FIG. 8A, description will be made regarding an example in which a server 7 has the management unit 33, and updates vehicle control map data using the vehicle control map data presence/absence table in a vehicle 9. With the vehicle 9, in a case in which a given route detected previously in the route search has a section for which the vehicle control map data exists, a local vehicle control map data storage unit 40 stores the vehicle control map data that corresponds such a section. It should be noted that this arrangement has the same configuration as the vehicle control system 1 except for the points that the management unit 33, vehicle control map data storage unit 21, and table storage unit 23 of the control apparatus 5 in the vehicle control system 1 described with reference to FIG. 1A are installed in the server 7 side, while the local vehicle control map data storage unit 40 is installed in the control apparatus 5.

FIG. 8B is a flowchart showing an example of table updating by the management unit of the server. The management unit repeats the processing of Steps STD1 through STD5 the same number of times as the number of intersections. An intersection polygon is identified for each of the multiple points representing intersections using the width of the road approaching the intersection and the width of the road exiting the intersection with reference to the vehicle control map data stored in the vehicle control map data storage unit (Step STD2). Subsequently, an intersection region including this intersection polygon is determined (Step STD3). Subsequently, each table is updated (Step STD4). The tables store the latest update date of the vehicle control map data for each section in units of sections. When updating processing has been completed for all the intersections, the management unit judges whether or not there is an intersection that has been deleted as a result of the updating (Step STD6). When no intersection is deleted, the processing ends. Conversely, when any intersection is deleted, the corresponding information is updated so as to give notice that this intersection has been deleted.

FIG. 8C is a flowchart showing an example of updating the local vehicle control map data storage unit in a moving body. The control unit downloads an updated vehicle control map data presence/absence table from the server, and stores it in the vehicle control map data presence/absence table storage unit (Step STE1). Subsequently, the navigation unit performs route searching using route search map data (step STE2), and acquires the coordinate position for each node in a route (Step STE3). The start point search unit 25 and judgment unit 27 of the control apparatus 5 perform start point search processing and matching processing using the vehicle control map data presence/absence table (Step STE4). In a case in which the vehicle control map data exists for a given section on a route, the vehicle control map data required for the section is downloaded (Step STE5) and updated (STEP STE6). It should be noted that the latest date of updating of the vehicle control map data presence/absence table and the date of updating of the vehicle control map data of the local vehicle control map data may be compared to judge the sections to be updated. Also, the vehicle control map data may be downloaded for only the sections to be updated.

The processing in Steps STE5 and STE6 is not nationwide but is restricted to areas where the updating is required. This dramatically reduces the time required for downloading and updating. It should be noted that, in the first stage, the updating may be performed for areas where the updating is required, e.g., for areas in the vicinity of the vehicle. In the second stage, when the vehicle is traveling or the like, the updating may be performed for the remaining areas nationwide.

According to the aspects of the present example, route search processing and vehicle control can be performed using route search map data and vehicle control map data, which are map data for different purposes. Furthermore, matching is executed based on the coordinate position for each intersection defined in both the route search map data and the vehicle control map data. This allows the corresponding information to be extracted in the data search even in a case of employing a plurality of map data managed in different data management methods (IDs or the like).

Particularly, a table is employed such that it stores only the data required for the matching processing, which is a part of data included in the vehicle control map data. This provides high-speed processing for identifying sections where the vehicle control map data exists. For example, the table uses polygonal intersection regions including intersection polygons. This markedly reduces the amount of data, and facilitates matching processing. Also, by employing the left-right judgment table, this provides high-speed matching processing without involving unnecessary matching processing.

Furthermore, the information with respect to the deletion of intersections executed in the vehicle control map data updating is managed by means of the table. Accordingly, even in a case in which the information with respect to the deletion of a particular intersection is not supplied from the route search map data because it has not been updated, this arrangement is capable of handling such a situation.

### REFERENCE SIGNS LIST

1 vehicle control system, 3 navigation apparatus, 5 control apparatus, 11 route search map data storage unit, 13 route information storage unit, 15 node coordinate list storage unit, 17 route search unit, 19 display unit, 21 vehicle control map data, 23 table storage unit, 25 start point search unit, 27 judgment unit, 31 vehicle control unit, 33 management unit.

1. A vehicle control system, comprising:
a route search map data storage unit configured to store route search map data;
a vehicle control map data storage unit configured to store vehicle control map data used for vehicle control;
a table storage unit configured to store a presence/absence management table;
a route search unit configured to identify position information of a plurality of nodes corresponding to intersections on a route, and link data connecting the nodes, using the route search map data; and
a judgment unit configured to judge sections on the route for which the vehicle control map data exists, which is used for vehicle control,
wherein the presence/absence management table comprises
position information representing an intersection region that is a polygonal region including an intersection in the vehicle control map data, and
presence/absence information representing presence or absence of vehicle control map data at a position corresponding to an intersection,
wherein, by searching in the route for a particular intersection having a position that can be judged to match a position within the intersection region based on comparison between position information with respect to the nodes in the route and position information representing the intersection regions, and by judging, based on the presence/absence information, the presence or absence of the vehicle control map data at a position that corresponds to the particular intersection, the judgment unit judges whether or not the vehicle control map data exists for a given section on the route.

2. The vehicle control system according to claim 1, wherein the table storage unit further stores a facility management table for identifying an intersection to be set as a start point of a section on the route for which the vehicle control map data exists,
and wherein the vehicle control system further comprises a start point search unit configured to acquire an intersection to be set as the start point with reference to the facility management table.

3. A management table production method for producing a management table that manages an intersection region determined using vehicle control map data to be used for vehicle control, wherein the vehicle control map data includes lane data with respect to lanes passable by a vehicle,
and wherein the management table production method comprises:
determining in which a management unit included in an information processing apparatus identifies an intersection polygon for each of a plurality of intersections based on a width of a road approaching the intersection and a width of a road exiting the intersection, and determines the intersection region including this intersection polygon; and
producing the management table by adding data with respect to the vehicle control map data that corresponds to each of the intersection regions thus determined.

4. The management table production method according to claim 3, further comprising updating the vehicle control map data,
wherein, in the determining and the producing, the management unit determines each intersection region using the updated vehicle control map data so as to produce the management table,
and wherein the management table production method further comprises deletion information adding in which, when an intersection has been deleted in updating of the vehicle control map data, the management unit adds information with respect to the corresponding intersection region, which indicates that the intersection has been deleted, to the updated management table.

5. A computer-readable recording medium storing a program for instructing a computer for vehicle control to function as:
a route search map data storage unit configured to store route search map data,
a vehicle control map data storage unit configured to store vehicle control map data to be used for vehicle control,
a table storage unit configured to store a presence/absence management table,
a route search unit configured to identify position information with respect to a plurality of nodes corresponding to intersections on a route, and link data connecting the nodes, using the route search map data, and
a judgment unit configured to judge sections on the route where the vehicle control map data exists, which are to be used for vehicle control,
wherein the presence/absence management table comprises
position information representing an intersection region configured as a polygonal region including an intersection in the vehicle control map data, and
presence/absence information that indicates presence or absence of vehicle control map data at a position corresponding to an intersection,
and wherein, by searching in the route for a particular intersection having a position that can be judged to match a position within the intersection region based on comparison between position information with respect to the nodes in the route and position information representing the intersection regions, and by judging, based on the presence/absence information, the presence or absence of the vehicle control map data at a position that corresponds to the particular intersection, the judgment unit judges whether or not the vehicle control map data exists for a given section on the route.
